(19) United States
(12) Patent Application Publication
(10) Pub. No.: US 2021/0133493 A1
(43) Pub. Date: May 6, 2021

(54) DISRUPTING OBJECT RECOGNITION FUNCTIONALITY

(71) Applicant: safeXai, Inc., Sandy, UT (US)

(72) Inventors: Joshua J. Newman, Park City, UT (US); Brian Rodriguez, Salt Lake City, UT (US)

(21) Appl. No.: 17/085,795

(22) Filed: Oct. 30, 2020

Related U.S. Application Data
(60) Provisional application No. 62/927,923, filed on Oct. 30, 2019.

(51) Int. Cl. G06K 9/62; G06K 9/00; G06K 9/36; G06N 3/04; G06N 3/08

(52) U.S. Cl. CPC G06K 9/6227; G06K 9/00778; G06N 3/08; G06N 3/0454; G06K 9/36

(57) ABSTRACT

Examples extend to methods, systems, and computer program products for disrupting object recognition functionality. Images can be altered in a manner that makes it difficult (if not impossible) for recognition algorithms to accurately recognize faces, vehicles, people, etc. in the images. Image alterations can be tailored to disrupt recognition algorithms while being imperceptible to the human eye and/or minimizing impact on other image processing systems. In some aspects, Machine Leaning (ML) frameworks and/or leaning-based generative/discriminative model techniques, such as, for example, Generative Adversarial Networks (GANs), are used to alter images.

### CROSS-REFERENCE TO RELATED APPLICATIONS

This application claims the benefit of U.S. Provisional Patent Application Ser. No. 62/927,923, entitled “Anonymizing Entities In Images”, filed Oct. 30, 2019, which is incorporated herein in its entirety.

### BACKGROUND

### Background and Relevant Art

It is relatively easy and cost-efficient to recognize objects, such as, persons, faces, vehicles, etc. in images and/or videos using automated and/or computerized systems. A recognition model and code can be downloaded from the Internet. Anyone with basic programming skills can use the model and code to configure an advanced automated recognition system with minimal effort. Recognition systems can be configured to recognize faces, license plates, etc. within images and/video.

Some entities (companies) create recognition systems internally and then release the recognition systems to the public. The entities themselves may refrain from using the recognition systems for morally and/or ethically questionable practices and may even object to such practices. However, customers/partners/employees can still access and misuse the technology, such as, for vehicle profiling, for racial profiling, etc.

### BRIEF SUMMARY

Examples extend to methods, systems, and computer program products for disrupting object recognition functionality. Images can be altered in a manner that makes it difficult (if not impossible) for recognition algorithms to accurately recognize faces, vehicles, people, etc. in the images. Image alterations can be tailored to disrupt recognition algorithms while being imperceptible to the human eye and/or minimizing impact on other image processing systems. In some aspects, Machine Leaning (ML) frameworks and/or leaning-based generative/discriminative model techniques, such as, for example, Generative Adversarial Networks (GANs), are used to alter images.

In one aspect, a capability reduction model is trained using a recognition algorithm. The capability reduction model is deployed. An image including an object recognizable by the recognition algorithm is accessed. The capability reduction model is applied to the image altering the image into an altered image Image alteration includes making minimal sufficient alterations to the object disrupting the capability of the recognition algorithm to recognize the object. The altered image is sent to the recognition algorithm. The image recognition algorithm generates reduced meaning output that does include recognition of the object.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 illustrates an example computer architecture that facilitates training a model to alter images in a manner that reduces recognition algorithm capabilities.

FIG. 2 illustrates a flow chart of an example method for training a model to alter images in a manner that reduces recognition algorithm capabilities.

FIG. 3 illustrates an example computer architecture that facilitates altering images to reduce recognition algorithm capabilities.

FIG. 4 illustrates a flow chart of an example method for altering images to reduce recognition algorithm capabilities.

### DETAILED DESCRIPTION

Examples extend to methods, systems, and computer program products for disrupting object recognition functionality. Aspects of the invention can be used to significantly reduce, if not entirely eliminate, the efficiency and effectiveness of recognition algorithms Images can be altered in a manner that makes it difficult (if not impossible) for recognition algorithms to accurately recognize faces, vehicles, people, etc. in the images Image alterations can be tailored to disrupt recognition algorithms while being imperceptible to the human eye and/or minimizing impact on other image processing systems.

In general, recognition algorithms can be designed to recognize specified entities (or objects) and/or characteristics, features, etc. thereof within images and/or video. For example, facial recognition algorithms can be used to recognize faces, vehicle recognition algorithms can be used to recognize vehicles, person recognition algorithms can be used to recognize persons/people, etc. Aspects of the invention include altering (anonymizing) portions of an image or video to reduce the efficiency and/or effectiveness of recognition algorithms (including any of the described example recognition algorithms) In some aspects, image alterations (possibly significantly) reduce recognition algorithm accuracy. In other aspects, image alterations cause recognition algorithms to take (possibly significantly) more time to perform a recognition. In further aspects, image alterations essentially “break” a recognition algorithm, preventing the recognition algorithm from recognizing specified entities (or objects) and/or characteristics, features, etc. thereof at all.

Accordingly, a recognition algorithm can be rendered practically (if not fully) ineffective, increasing the privacy of people, vehicles, faces, etc. contained in images. For example, it may take a recognition algorithm an inordinate amount of time to recognize a specified object in an altered (anonymized) image. By the time the specified object is recognized, the recognition may no longer have meaning. In another example, recognition accuracy is reduced enough such that recognitions are essentially meaningless.

Generally, the more an image is changed the less useful the image content is to customers/partners, etc. If an image is completely changed (or removed), then image content is essentially useless to customers/partners. Accordingly, image alterations can be tailored to disrupt recognition algorithms but cause minimal changes to visual perception and/or image characteristics used by other systems. In one aspect, images/videos can be altered in a smaller way (or the smallest way possible) that causes significant difficulties for (or “breaks”) a recognition algorithm. For example, an image/video change or changes may be sufficient to significantly reduce recognition algorithm efficiency/effectiveness but are imperceptible to the human eye (a human viewer) and/or do not significantly impact other image processing systems (e.g., crowd detection systems, traffic congestion systems, etc.).

Machine Leaning (ML) frameworks and/or leaning-based generative/discriminative model techniques, such as, for example, Generative Adversarial Networks (GANs), can be used to alter images. The frameworks, techniques, networks, etc. can learn to minimize image alterations while still (potentially significantly) reducing recognition algorithm efficient/effectiveness.

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: training images, recognition algorithms, other algorithms, human perception algorithms, altered images, algorithm thresholds, algorithm results, threshold results, recognition thresholds, other thresholds, image alteration models, video streams, videos, video frames, images, reduced meaning output, functional output, imperceptibly changed visualizations, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, training images, recognition algorithms, other algorithms, human perception algorithms, altered images, algorithm thresholds, algorithm results, threshold results, recognition thresholds, other thresholds, image alteration models, video streams, videos, video frames, images, reduced meaning output, functional output, imperceptibly changed visualizations, etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more Field Programmable Gate Arrays (FPGAs) and/or one or more application specific integrated circuits (ASICs) and/or one or more Tensor Processing Units (TPUs) can be programmed to carry out one or more of the systems and procedures described herein. Hardware, software, firmware, digital components, or analog components can be specifically tailor-designed for a higher speed detection or artificial intelligence that can enable signal processing. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

In this description and the following claims, a “Machine Learning (ML) Framework” is defined as an interface, library or tool allowing developers to more easily and quickly build machine learning models and abstracting underlying algorithms An ML framework can provide a clear, concise way for defining machine learning models using a collection of pre-built, optimized components. Generally, ML frameworks reduce the complexity of machine learning, making it accessible to more developers.

In this description and the following claims, a “generative model” is defined as a model configured to generate new data instances, for example, new images.

In this description and the following claims, a “discriminative model” is define as a model configured to discriminate between different kinds of data instances, for example, distinguish a dog from a cat in an image.

In this description and the following claims, a “Generative Adversarial Network (GAN)” is defined as an ML framework using generative and discriminative models where neural networks compete against each other in a game (e.g., a zero-sum game) where one agent's gain is another agent's loss. In one aspect, there are two networks a “generator/generative” network (e.g., based on a generative model) and a “discriminator/discriminative” network (e.g., based on a discriminative model). Generally, the generative network learns to map from a latent space to a data distribution of interest, while the discriminative network distinguishes candidates produced by the generator from the true data distribution. An objective of the generative network's training is to irlcrease the error rate of the discriminative network. That is, generative network attempts to fool the discriminative network by producing novel candidates that the discriminator thinks are not synthesized (are part of the true data distribution).

A generator can train based on whether it succeeds in fooling the discriminator. Typically the generator is seeded with randomized input that is sampled from a predefined latent space (e.g. a multivariate normal distribution). Thereafter, candidates synthesized by the generator are evaluated by the discriminator. Independent backpropagation procedures can be applied to both networks so that the generator produces better images, while the discriminator becomes more skilled at flagging synthetic images. In one aspect, the generator is a deconvolutional neural network and the discriminator is a convolutional neural network. Overtime, the discriminator improves at classifying real and fake images and the generator learns how to make incredibly good fake data (i.e., very realistic), for example, image alterations. Accordingly, a generator can be trained in such a way that it learns the smallest possible image alteration that confuses the corresponding discriminator.

For example, aspects of the invention can train a GAN to make small (and potentially the smallest possible) modifications to people's faces, bodies and vehicles making automated (e.g., facial, vehicle, etc.) recognition very difficult. The generator can train a model against recognition algorithms it is trying to fool (facial recognizer, racial profiler, vehicle identifier, etc.). The trained model can then be run (e.g., as preprocessing) over videos/images to make it more difficult for the recognition algorithms to recognize faces, race, human body features, vehicle type, vehicle color, license plate, etc. from the videos/images. When image alteration is performed as a preprocessing activity, recognition algorithm efficiency/effective can be reduced even if employees/customers/partners etc. try to use a recognition algorithm.

In other aspects, unmodified images are used within a host (and possibly secure) system, such as, for example, a network of interconnected computers and signal processing modules under common control. As such, within the host system, facial recognition, race recognition, vehicle identification, etc. algorithms work efficiently and effectively as designed on video/images. The trained model is run on the video/images before the video/images are propagated outside the host system (e.g., as post processing), such as, for example, when video/images are sent to a client/customer.

In further aspects, models within a host system are retrained with old data and newly generated data from one or more GANs. Retraining the models makes the models more robust to video/image modifications introduced through pre-processing by the one or more GANs. However, the video/image modifications can still reduce the efficiency and/or effectiveness of identification and/or recognition systems used outside the host system.

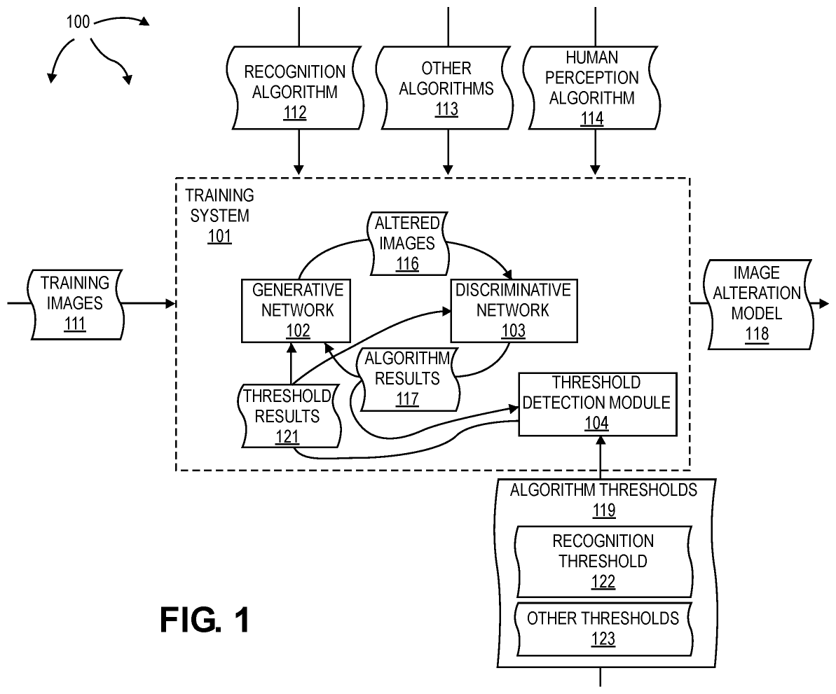

FIG. 1 illustrates an example computer architecture 100 that facilitates training a model to alter images in a manner that reduces recognition algorithm capabilities. As depicted, computer architecture 100 includes training system 101. Training system can be connected to (or be part of) a network, such as, for example, a system bus, a Local Area Network (“LAN”), a Wide Area Network (“WAN”), and even the Internet. Accordingly, training system as well as any other connected computer systems and their components can create and exchange data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

As depicted, training system 101 further includes generative network 102 discriminative network 103, algorithm threshold detection module 104. Training system 101 can access training images 111, recognition algorithm 112, other algorithms 113, and human perception algorithm 114. Training images 111 can be images (e.g., still images, video frames, etc.) including one or more humans and/or one or more vehicles, such as, for example, images of a roadway, a sidewalk, a sporting event, a convert, a parking lot, etc. Recognition algorithm 112 can be an algorithm that recognizes any of: faces, race, human body features, vehicle type, vehicle color, license plate, etc. from the content videos/images. Other algorithms 113 can be algorithms that perform other activities based on the content of videos/images, such as, for example, traffic congestion detection algorithms, crowd detection algorithms, etc. Human perception algorithm 114 represents what changes in a video/image are generally perceptible to a human and what changes in a video/image are generally not perceptible to a human Human perception algorithm 114 can take into consideration that visual acuity among the human population varies.

On an ongoing basis, generative network 102 can alter images (either training images or other previously altered images) and send altered images 116 to discriminative network 103. Discriminative network 103 can apply recognition algorithm to altered images 116. The efficiency and/or effectiveness of recognition algorithm 112 can be determined and included in algorithm results 117. Algorithm results 117 can be sent back to generative network 102 as feedback and also sent threshold detection network 104.

Threshold detection network 104 can access algorithm thresholds 119. Algorithm thresholds 119 can define a threshold 122 indicating desired capability reduction of recognition algorithm. Threshold detection module 104 can compare algorithm results 117 to threshold 122 generating threshold results 121. Threshold module 104 can send threshold results 121 to generative network 102 and to discriminative network 103. Generative network 102 can consider threshold results 121 when making subsequent image alterations. Discriminative network 103 can consider threshold results 121 when attempting to discriminate subsequent altered images.

Training can continue on an ongoing basis, with generative network 102 making image alterations and discriminative network attempting recognitions, until recognition threshold 122 is satisfied. When threshold results 121 indicate capability recognition reduction satisfying recognition threshold 122, training can end. Training system 101 can then output image alteration model 118 modeling the image alteration perations that resulted in satisfaction recognition threshold 122.

In aspects, the efficiency and/or effectiveness of other algorithms 113 and/or of human perception algorithm 114 can also be determined and included in algorithm results 117. Algorithm results 117 can be sent back to generative network 102 as feedback and also sent threshold detection network 104.

Algorithm thresholds 119 can also define other thresholds 123. Other thresholds 123 can indicate a minimal capability reduction to other algorithms 113 and/or a minimum reduction capability in human perception algorithm 114. Threshold detection module 104 can check algorithm results 117 against recognition threshold 122 as well as against other thresholds 123 generating threshold results 121. Generative network 102 can consider threshold results 121 when making subsequent image alterations. Discriminative network 103 can consider threshold results 121 when attempting to discriminate subsequent altered images.

Training can continue on an ongoing basis, with generative network 102 making image alterations and discriminative network attempting recognitions, until recognition threshold 122 and other thresholds 123 are satisfied. When threshold results 121 indicate both (a) capability reduction satisfying recognition threshold 122 and (b) minimized capability reduction satisfying other thresholds 123, training can end. Training system 101 can then output image alteration model 118 modeling the image alteration operations that resulted in satisfaction recognition threshold 122 and other thresholds 123. As such, image alteration model 118 is configured to alter images in a way that sufficiently reduces the recognition capability of recognition algorithm 118 rendering recognition algorithm ineffective. Image alteration model 118 is also configured to alter images in a way that minimizes capability reduction of other algorithms 113. Image alteration model 118 is also configured to alter images in a way that is not perceptible to human beings.

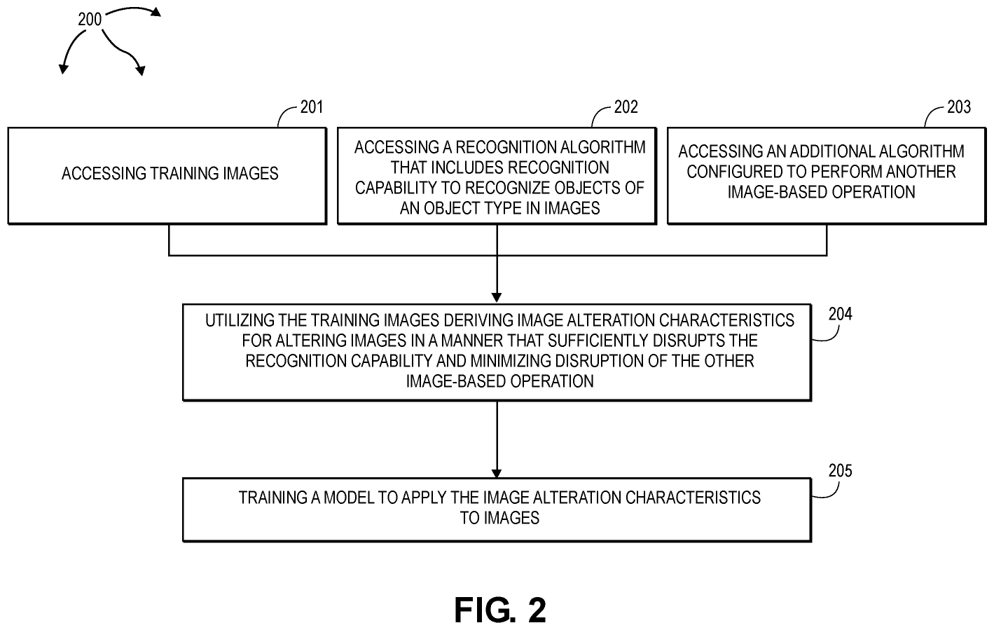

FIG. 2 illustrates a flow chart of an example method 200 for training a model to alter images in a manner that reduces recognition algorithm capabilities. Method 200 will be described with respect to the components and data in computer architecture 100.

Method 200 includes accessing training images (201). For example, training system 101 can access training images 111. Method 200 includes accessing a recognition algorithm that includes recognition capability to recognize objects of an object type in images (202). For example, training system 101 can access recognition algorithm 112. Method 200 includes accessing an additional algorithm configured to perform another image-based operation on images (203). For example, training system 101 can access one or more other algorithms 112 and/or human perception algorithm.

Method 200 includes utilizing the training images deriving image alteration characteristics for altering images in a manner that sufficiently disrupts the recognition capability and minimizing disruption of the other image-based operation (204). As described, training system 101 can utilize training images 111 to derive image alteration characteristics for altering images. Based on algorithm thresholds 119, training system 101 can derive image alteration characteristics for sufficiently disrupting the recognition capabilities of recognition algorithm 112 and that also minimizes disruptions to the capabilities of other algorithms 113 and/or human perception algorithm 114.

Method 200 includes training a model to apply the image alteration characteristics to images (205). For example, training system 101 can train image alteration model 118 to apply image alteration characteristics the sufficiently disrupt the recognition capabilities of recognition algorithm 112 and also minimize disruptions to the capabilities of other algorithms 113 and/or presentation of image based visualizations.

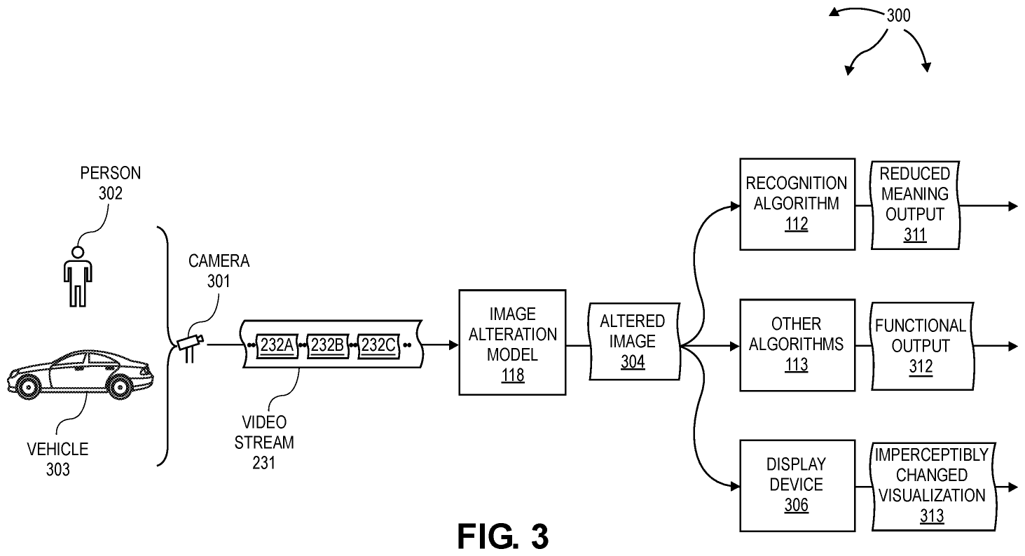

FIG. 3 illustrates an example computer architecture 300 that facilitates altering images to reduce recognition algorithm capabilities. As depicted, computer architecture 300 includes camera 301, image alteration model 118, recognition algorithm 112, other algorithms 113, and display device 306. Training system can be connected to (or be part of) a network, such as, for example, a system bus, a Local Area Network (“LAN”), a Wide Area Network (“WAN”), and even the Internet. Accordingly, training system as well as any other connected computer systems and their components can create and exchange data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

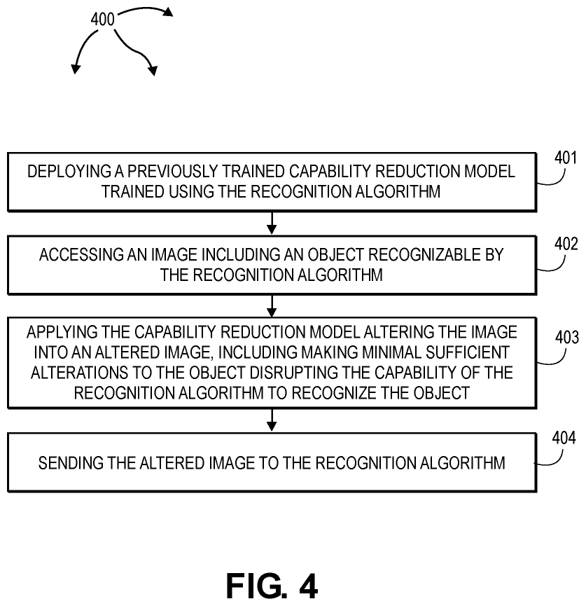

FIG. 4 illustrates a flow chart of an example method 400 for altering images to reduce recognition algorithm capabilities. Method 400 will be described with respect to the components and data in computer architecture 300.

Method 400 includes deploying a previously trained capability reduction model trained using the recognition algorithm (401). For example, image alteration model 118 can be deployed into computer architecture 300.

Method 400 includes accessing an image including an object recognizable by the recognition algorithm (402). For example, camera 201 can capture video stream 331, including frames 332A, 332B, 332C, etc. Video stream 331 can include one or more of frames of person 302 and/or vehicle 303 Image alteration model 118 can access video stream 331.

Method 400 includes applying the capability reduction model altering the image into an altered image, including making minimal sufficient alterations to the object disrupting the capability of the recognition algorithm to recognize the object (403). For example, image alteration model 118 can alter one or more of frames 332A, 332B, 333C, etc. into altered image 304. Image alteration model 118 can make minimal alterations to person 302 and/or vehicle 303 to disrupt the capability of recognition algorithm 112 to recognize person 302 and/or vehicle 303.

Method 400 includes sending the altered image to the recognition algorithm (404). For example, image alteration model 118 can send altered image 304 to recognition algorithm 112.

Recognition algorithm 112 can attempt to recognize objects (e.g., person 302 and/or vehicle 303) in altered image 304. Recognition algorithm 112 can generate reduced meaning output 211 that does not sufficiently (or at all) recognize objects (e.g., person 302 and/or vehicle 303) due to alterations made by image alteration model 118.

Image alteration model 118 can also send altered image 304 to other algorithms 113 and display device 306. Other algorithms 113 can generate functional output 312. Functional output 312 can be essentially the same output other algorithms 113 would have generated from processing video stream 331 (e.g., frames 332A, 332B, 232C, etc.) prior to alteration. Display device 306 can present imperceptibly changed visualization 313 of altered image 304. Imperceptibly changed visualization 313 can be essentially the same as a visualization presented directly from video stream 331 (e.g., frames 332A, 332B, 332C, etc.). In general, the visualizations can be so similar that a human being is unable to perceive any difference.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A method for reducing recognition capability of a recognition algorithm, comprising:
deploying a previously trained capability reduction model trained using the recognition algorithm;
accessing an image including an object recognizable by the recognition algorithm;
applying the capability reduction model altering the image into an altered image, including making minimal sufficient alterations to the object disrupting the capability of the recognition algorithm to recognize the object; and
sending the altered image to the recognition algorithm.

2. The method of claim 1, further comprising training and tailoring the capability reduction model using a Generative Adversarial Network (GAN) prior to applying the model.

3. The method of claim 1, wherein accessing an image comprises accessing an image that includes a person; and
wherein applying the capability reduction model comprises altering the image in a manner that (a) is imperceptible to a human viewer of the image but (b) sufficient to reduce the ability of the recognition algorithm to accurately recognize the person.

4. The method of claim 1, wherein accessing an image comprises accessing an image that includes a vehicle; and
wherein applying the capability reduction model comprises altering the image in a manner that is (a) imperceptible to a human viewer of the image but (b) sufficient to reduce the ability of the recognition algorithm to accurately recognize the vehicle.

5. The method of claim 1, wherein accessing an image comprises accessing an image that includes a face; and
wherein applying the capability reduction model comprises altering the image in a manner that is (a) imperceptible to a human viewer of the image but (b) sufficient to reduce the ability of the recognition algorithm to accurately recognize the face.

6. The method of claim 1, wherein accessing an image comprises accessing an image that includes a person; and
wherein applying the capability reduction model comprises altering the image in a manner that (a) is sufficient to reduce the ability of the recognition algorithm to accurately recognize the person and (b) minimizes impact on another algorithm; and
further comprising:
sending the altered image to the other algorithm; and
accessing functional output from the other algorithm processing the altered image.

7. The method of claim 6, wherein altering the image in a manner that minimizes impact on another algorithm comprises altering the image in a manner that minimizes impact on one of: a congestion detection algorithm or a crowd detection algorithm; and
wherein sending the altered image other algorithm comprises sending the altered image to the one of: the congestion detection algorithm or the crowd detection algorithm.

8. The method of claim 1, wherein accessing an image comprises accessing an image that includes a vehicle; and
wherein applying the capability reduction model comprises altering the image in a manner that (a) is sufficient to reduce the ability of the recognition algorithm to accurately recognize the vehicle and (b) minimizes impact on another algorithm; and
further comprising:
sending the altered image other algorithm; and
accessing functional output from the other algorithm processing the altered image.

9. The method of claim 8, wherein altering the image in a manner that minimizes impact on another algorithm comprises altering the image in a manner that minimizes impact on one of: a congestion detection algorithm or a crowd detection algorithm; and
wherein sending the altered image to the other algorithm comprises sending the altered image to the one of: the congestion detection algorithm or the crowd detection algorithm.

10. The method of claim 1, wherein accessing an image comprises accessing an image that includes a face; and
wherein applying the capability reduction model comprises altering the image in a manner that (a) is sufficient to reduce the ability of the recognition algorithm to accurately recognize the face and (b) minimizes impact on another algorithm; and
further comprising:
sending the altered image other algorithm; and
accessing functional output from the other algorithm processing the altered image.

11. The method of claim 1, wherein altering the image in a manner that minimizes impact on another algorithm comprises altering the image in a manner that minimizes impact on one of: a congestion detection algorithm or a crowd detection algorithm; and
wherein sending the altered image other algorithm comprises sending the altered image to the one of: the congestion detection algorithm or the crowd detection algorithm.
